(19) United States
(12) Patent Application Publication
(10) Pub. No.: US 2005/0226327 A1
(43) Pub. Date: Oct. 13, 2005

(54) MPEG coding method, moving picture transmitting system and method using the same

(76) Inventor: Seong-bong Kim, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/811,805

(22) Filed: Mar. 30, 2004

(51) Int. Cl. H04N 7/12

(52) U.S. Cl. 375/240.12; 375/240.01

(57) ABSTRACT

An improved MPEG coding method for a moving picture signal, and a system and method for transmitting coded moving picture data using the improved MPEG coding method, fixes an object, selected as a reference frame of inter-frames, to an intra-frame. The moving picture transmission system includes a video processing unit for processing and coding a received video signal receiving a video signal using the improved MPEG coding method, and a transmission unit for transmitting the coded moving picture data in real time, adapting the data to a variation in a network transmission rate. Accordingly, moving picture data, received from a remote fixed camera and coded, can be transmitted in real time, being adapted to a flexible transmission rate of a network.

### BACKGROUND AND SUMMARY

1. Technical Field

The present invention relates to an improved MPEG (Moving Picture Experts Group) coding method and a moving picture processing system using the same. Specifically, the invention relates to a moving picture transmitting system and method for compressing video data inputted through a remote fixed camera using an improved MPEG coding method and transmitting the video data compressed being adapted to network environments to a remote decoder using data loss rate increased according to the improved MPEG coding method.

2. Description of the Related Art

MPEG used is a standard organization established under ISO (International Organization for Standardization) by the video coding standardization committee. MPEG provides the standards of moving picture coding and decoding algorithms. The moving picture information coding principle used for MPEG is composed of three parts: spatial correlation, temporal correlation and preponderance of probability of code generation. Coding according to the spatial correlation is a technique employing a JPEG (Joint Photographic Experts Group) method. JPEG is a lossy compression method that executes a DCT (Discrete Cosine Transform) algorithm to divide the spatial frequency of an image into high-frequency and low-frequency components, and to eliminate high-frequency component which are difficult for people to recognize by their sensory organs. Coding according to the preponderance of probability of code generation is a technique that provides a short code to data with a high probability of generation among data contents constructing an image, and provides a long code to data with a low probability of generation.

In the case that all of the frames (30 frames per second, for example) compressed through a conventional MPEG coding method are to be transmitted, they may not be transmitted in real time because of characteristics of wired/wireless channels. Especially, in the case of transmission of coded moving picture data using the public switched telephone network (PSTN) or integrated services digital network (ISDN), it is typical to transmit only a limited number of frames, restricted by the supported transmission rate.

In the meantime, coding using the temporal correlation in the conventional MPEG coding method employs the structure of intra-picture (I-picture) frames and inter-picture (Predictive-picture (P-picture) and Bidirectionally predictive-picture: P-picture and B-picture) frames. Here, when the I/P frame structure is applied, arbitrary frames are discarded with reference to the state of a transmission channel so that it is difficult to normally reconstruct a received image. This is because correlation between neighboring frames is used in the conventional MPEG coding so that reconstruction of image cannot be carried out without having neighboring frames. When the I/P/B frame structure is applied to the MPEG coding, it is possible to normally reconstruct the received image even if B-frames are discarded. However, there is a limitation in the number of B frames in one GOP (Group of Pictures) because of reordering delay and necessity of a frame memory for reordering. That is, there is a considerable limitation in allowable frame loss rate in the conventional MPEG coding method.

According to the conventional coding method as described above, allowable frame loss rate is low so that it is difficult to select various compression rates according to the quantity of storage space. In addition, it is impossible to adapt to a variation in transmission rate on a network, resulting in a difficulty in real-time transmission.

In case of an application such as a security system, especially, images photographed by a fixed camera have very high temporal correlation. However, the conventional moving picture coding and transmitting system cannot properly use this characteristic, so the quantity of data cannot be adaptively controlled according to characteristics of a storage medium and a transmission medium.

Accordingly, it would be desirable to provide an improved MPEG coding method to increase allowable frame loss rate in view of the fact that, in the case that temporal correlation of input images is high because of utilization characteristics and mechanical characteristics of an image input device, there are lots of data restorable to the original images even after being lost among moving picture coding data contents. It would also be desirable to provide a moving picture transmitting system and method for transmitting real-time moving picture coding data adaptively to flexible network environments using the improved MPEG coding method and allowing a user to flexibly control the rate of storing moving picture data according to the capacity of a storage medium. The present invention is directed to addressing one or more of these concerns.

In one aspect of the invention, a system for coding a video signal received from a moving picture input device, and transmitting the coded moving picture data through a network, uses an improved MPEG coding method that fixes an object to be selected as a reference frame of inter-frames from a GOP, to an intra-frame. Accordingly, the frames of the coded data which do not affect restoration of the coded data to the original image even if they are lost, is expanded to include all of the inter-frames of a GOP.

The system for coding a video signal received from the moving picture input device through the improved MPEG coding method and transmitting the coded moving picture data through a network includes a video processing unit for receiving the video signal from the moving picture input device and processing it, and a transmission unit for transmitting the moving picture data coded by the video processing unit in real time, adapting the data to a variation in a network transmission rate.

Furthermore, the moving picture transmission system using the improved MPEG coding method further includes: (a) a storage frame selector for receiving the moving picture data coded by the video processing unit and selecting frames to be stored on the basis of the number of storage frames per unit time, set by a user; and (b) a storage unit for storing the frames selected by the storage frame selector.

In another aspect of the invention, a method for coding a video signal inputted from a moving picture input device through the improved MPEG coding method, and transmitting the coded moving picture data through a network, comprises: a step (a) of processing the video signal received from the moving picture input device to convert it into ordered data and coding the data through the improved MPEG coding method; and a step (b) of transmitting the coded video data in real time at a data loss rate adapted to a variation in a network transmission rate.

Furthermore, the moving picture transmitting method using the improved MPEG coding method further comprises a step (c) of storing the coded video data at a rate of a number of stored frames per unit time that has been previously set by a user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 shows the relationship between each frame and reference frame in an improved MPEG coding method according to a preferred embodiment in comparison with that in a conventional MPEG coding method.

FIG. 2 is a block diagram showing the construction of a moving picture transmission system using the improved MPEG coding method according to a first embodiment.

FIG. 3A is a flow chart showing a moving picture transmitting method using the improved MPEG coding method according to a first embodiment.

FIG. 3B shows the internal structure of a transfer buffer of the moving picture transmission system using the improved MPEG coding method.

FIG. 4 is a block diagram showing the construction of a moving picture transmission system using the improved MPEG coding method according to a second embodiment.

FIG. 5A is a flow chart showing a moving picture transmitting method using the improved MPEG coding method according to a second embodiment.

FIG. 5B shows the structure of data stream for explaining the operation of a storage frame selector of a moving picture storage system using the improved MPEG coding method.

### DETAILED DESCRIPTION

MPEG video signal encoding has a multi-processing system structure, including a group of pictures (GOP) layer, a picture layer, a slice layer, a macro-block layer, and a block layer.

Meanwhile, in general, images photographed by a camera in real time have high correlation between neighboring frames. Correlation between neighboring frames is especially very high when the camera is fixed so that there is no variation the background. Accordingly, pictures photographed by a camera used in a security system have very high correlation between frames because the camera is used in a fixed manner. This is in contrast to a moving camera that is repeatedly fixed and moved so that images captured by the moving camera have relatively low correlation between neighboring frames.

As disclosed in further detail below, in accordance with one or more aspects of the present invention, an MPEG video signal encoding process is improved or modified by taking advantage of this high temporal correlation in a coding step. An image inputted through an input device is converted to an ordered digital data stream through signal processing and passes through a coding step according to spatial correlation using a still image coding technique having DCT as a main algorithm.

A reference frame is selected from a GOP that is the frame coding unit to extract only a portion varied according to temporal correlation and the extracted portion is coded once more according to a motion vector technique.

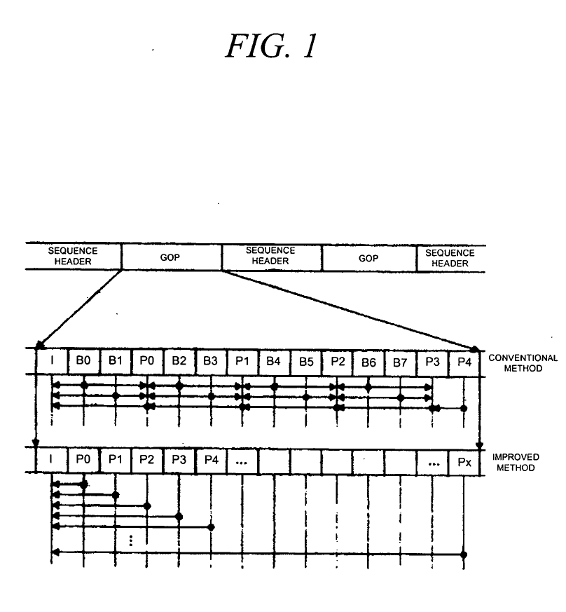

FIG. 1 shows the relationship between each frame and reference frame in an improved (or modified) MPEG coding method including a coding step using the motion vector technique, in comparison with that in the conventional MPEG coding method.

The conventional MPEG coding method, which in general is designed to operate with images from fixed cameras and moving cameras, constructs a GOP, the coding unit, using an I-picture (i.e., an intra-frame) obtained by coding all information of an image, and B-pictures (Bi-directionally predictive pictures) and P-pictures (Predictive pictures) that are inter-frames coded using temporal correlation with neighboring frames. A P-picture has been forward-predictive-coded (which means that information of a picture is obtained from the previous picture) using a P-picture or I-picture located in front of it as a reference frame. That is, the P-picture has been coded using the frame before itself as a reference frame. A B-picture is a coded picture that has been bi-directionally predictive coded using P-pictures and/or I-pictures located before and after it.

The improved (or modified) MPEG coding method constructs each GOP of a single I-picture and a plurality of P-pictures in order to utilize characteristics of an image captured by a fixed camera that is easy to install and has a little background variation. Here, the reference frame according to temporal correlation of the P-pictures is limited to the I-picture in the same GOP and coded. Accordingly, frames that could be lost, which were limited to B-picture frames in the prior art, are now expanded to include all frames other than the I-picture frames, so that allowable frame loss rate can be increased.

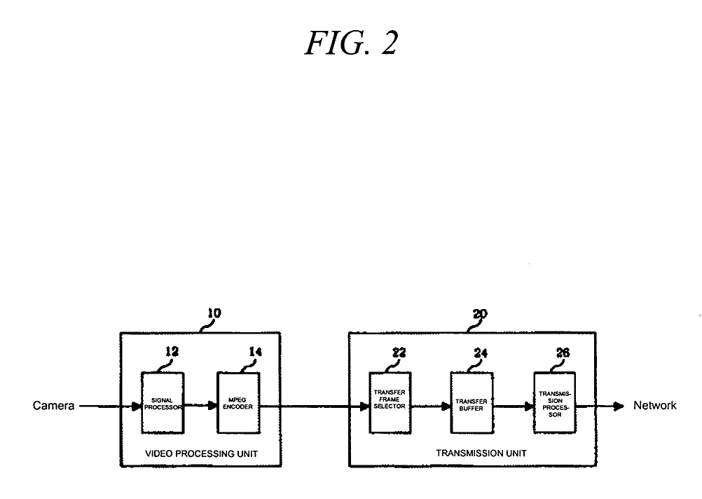

Referring to FIG. 2, a moving picture transmission system using the improved (or modified) MPEG coding method according to first embodiment includes a video processing unit 10 and a transmission unit 20. The video processing unit 10 has a signal processor 12 and an MPEG encoder 14, and converts a video signal inputted through a moving picture input device (not shown) into digital video data. The moving picture input device generally converts an analog input signal into a digital signal, and outputs the digital signal. When the input device does not execute this conversion operation, however, the signal processor 12 performs A/D conversion first, and then carries out noise removal, ordering signals to fit them to MPEG standards, and other filtering operations. The MPEG encoder 14 encodes the video data using the improved (or modified) MPEG coding method described above with reference to FIG. 1 and transmits the encoded video data to the transmission unit 20.

The transmission unit 20 includes a transfer frame selector 22, a transfer buffer 24 and a transmission processor 26. The transmission unit 20 transmits the moving picture data encoded by the video processing unit 10 in real time, adapting it to variations in a network transmission rate.

The transfer frame selector 22 receives the video data encoded by the video processing unit 10 and selects video data encoded in units of frames according to remaining capacity in the transfer buffer 24 to deliver the selected data to the transfer buffer 24. The transfer buffer 24 temporarily stores the frames of encoded video data selected by the transfer frame selector 22. The transmission processor 26 extracts the encoded video data temporarily stored in the transfer buffer 24 and converts it into a transfer standard that satisfies a network state to transmit it.

The transmission rate of bit streams extracted from the transfer buffer 24 and transmitted by the transmission processor 26 varies with the kind and state of a transmission medium. Accordingly, the transfer frame selector 22 selects frames to be stored in the transfer buffer 24 according to remaining capacity of the transfer buffer 24, determined by a variation in the transmission rate, and causes unselected frames be lost.

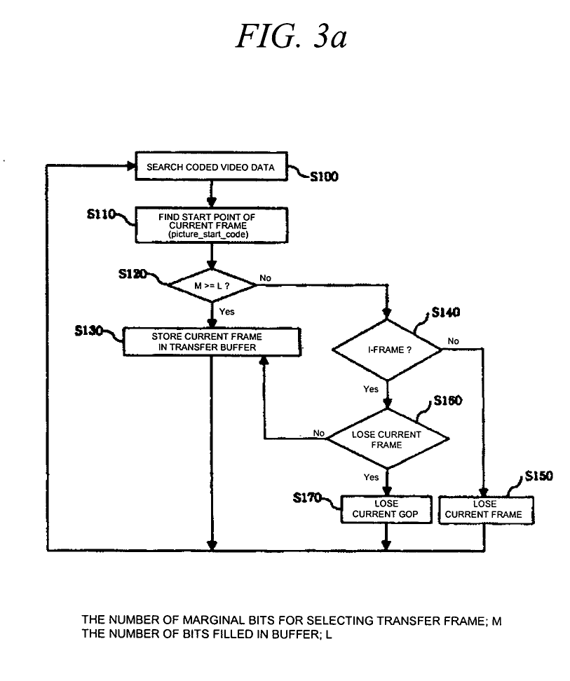

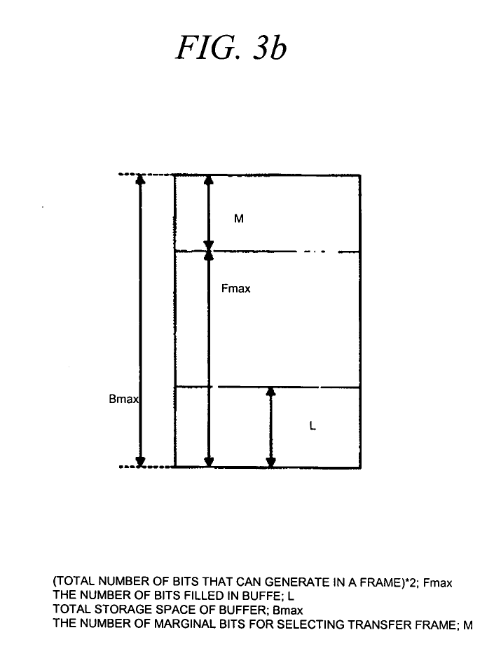

The operation of the transfer frame selector 22 is explained in more detail with reference to FIGS. 3A and 3B.

In FIG. 3B, Bmax denotes the total storage space of the transfer buffer 24, M represents the number of marginal bits for selecting transfer frames, L indicates the number of bits occupied in the transfer buffer 24, and Fmax denotes twice the total number of bits that can be generated in a single frame.

Referring to FIG. 3A, the transfer frame selector 22 receives the video data encoded by the video processing unit 10 to search it for the start point of the current frame using picture_start_code, though steps S100 and S110. Then, the transfer frame selector 22 compares the value L with the value M of the transfer buffer 24 at step S120, to carry out the following operations according to the comparison result.

1) In case of L≦M.

All of bit streams of the current frame are transmitted to the transfer buffer 24 and stored therein at step S130.

2) In case of L>M.

The following operations are performed according to the kind of current frame at step S140.
(1) When the current frame is an inter-frame (P), the current frame is lost or dropped at step S150.
(2) When the current frame is an intra-frame (I), all frames of the GOP to which the current intra-frame belongs are lost if the frame delivered to the transfer buffer 24 immediately prior to the current frame was an intra-frame, at steps S160 and S170. When the frame transmitted to the transfer buffer 24 immediately before the current frame is an inter-frame, the current intra-frame is transmitted to the transfer buffer 24 and stored therein at steps S160 and S130.

Subsequently, the steps following the step S100 are repeated, to transmit the bit streams of the encoded video data, delivered from the video processing unit 10, through a network. Here, in the case that the previous steps follow the step S170, the step S110 finds the start point of the I-frame of a new GOP using GOP_start_code.

Here, the value of (Bmax−M)=Fmax must be more than twice the total number of bits that can be generated in a single frame in order to prevent the transfer buffer 24 from overflowing. For this, the value M can be experimentally determined according to the video signal inputted through the image input device.

A moving picture transmission system using the improved (or modified) MPEG coding method according to a second embodiment further includes a storage unit for storing the encoded moving picture data, in addition to the above-described components.

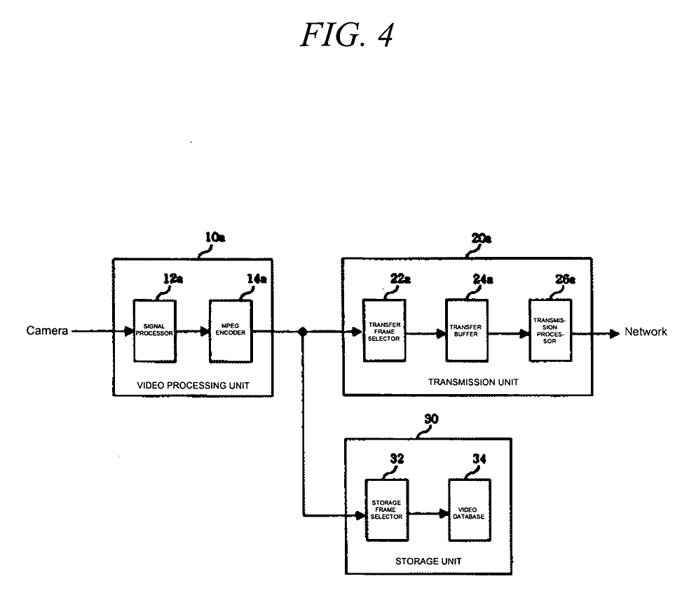

Referring to FIG. 4, a moving picture transmission system using the improved MPEG coding method according to a second embodiment includes: a video processing unit 10a having a signal processor 12a and an MPEG encoder 14a; a transmission unit 20a including a transfer frame selector 22a, transfer buffer 24a and a transmission processor 26a; and a storage unit 30 having a storage frame selector 32 and a moving picture database 34. Here, the video processing unit 10a and transmission unit 20a have the same functions as those of the video processing unit 10 and transmission unit 20 of the moving picture transmission system according to the first embodiment of FIG. 2 so that detailed explanations therefore are omitted.

The storage frame selector 32 receives video data encoded by the video processing unit 10a and selects frames to be stored in the moving picture database 34 on the basis of the number of storage frames per unit time, set by a user.

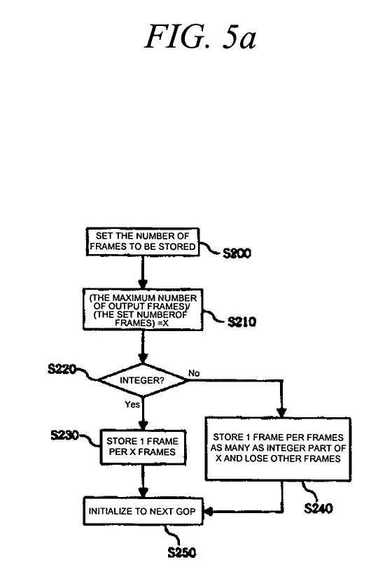

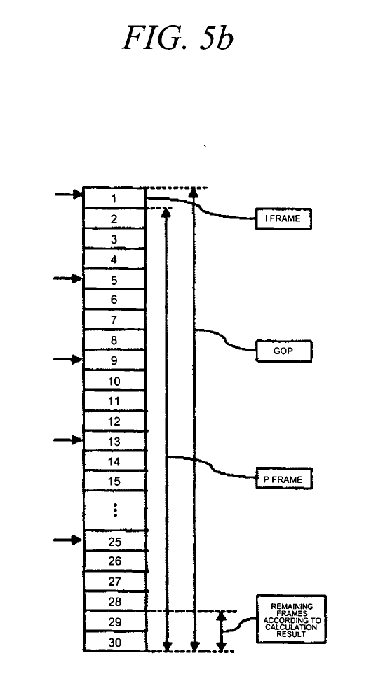

The procedure of selecting the frames to be stored is explained in more detail with reference to FIG. 5A.

The storage frame selector 32 receives the number of frames to be recorded from the user at step S200, and obtains a value X by dividing the maximum number of output frames of the encoded video data, by the number of frames to be recorded at step S210. Here, when the value X is an integer, only one frame for X frames is stored for each GOP in the encoded video data, at steps S220 and S230. When the value X is not an integer, only one frame is stored for frames as many as the value corresponding to the integer part of X, and other frames are lost, at steps S220 and S240. At step S250, then, the procedure is initialized to go to the next GOP and to repeat the step S230 or S240.

An example of the procedure shown in FIG. 5A is explained with reference to FIG. 5B.

If the maximum number of frames outputted from the MPEG encoder 14a is thirty frames per second (corresponding to one GOP) and the user sets the number of frames to be recorded to 7 per second, the value X becomes approximately 4.3. If one frame is stored for every four or five frames irrespective of the size of the GOP, a considerable number of I-frames are lost so that all P-frames using the lost I-frames as reference frames are lost. To prevent this, one out of every four frames is stored up to the first seven frames for every GOP, and the twenty-ninth and thirtieth frames are lost or dropped. In this manner, I-frames belonging to all GOPs can be stored without being lost or dropped.

In the moving picture transmission system using the improved (or modified) MPEG coding method according to the second embodiment, the storage unit 30 and transmission unit 20a can be simultaneously operated irrespective of external environments.

As described above, when a remote fixed camera is used for security purpose or other special purposes, encoded images can be transmitted on a network in real time, being adapted to a variation in a transmission rate of the network. Furthermore, the encoded images can be recorded at different storage rates according to the kind or capacitance of a storage medium and importance of the recording images. Accordingly, a security system that covers remote places as well as near places can be flexibly constructed.

The forgoing embodiments are merely exemplary and are not to be construed as limiting the present invention. The present teachings can be readily applied to other types of apparatuses. The description is intended to be illustrative, and not to limit the scope of the claims. Many alternatives, modifications, and variations will be apparent to those skilled in the art.

1. A moving picture transmission system using a modified MPEG coding method, comprising;
a video processing unit, comprising,
a signal processor adapted to receive a video signal and convert the video signal into digital video data when it is an analog video signal, and
an MPEG encoder adapted to encode the digital video data according to temporal correlation using a modified MPEG coding method that fixes an object, selected as a reference frame of inter-frames in each Group of Pictures (GOP), to an intra-frame, and adapted to output frames comprising the encoded digital video data;
a transmission unit, comprising,
a transfer buffer for temporarily storing selected ones of the frames of encoded digital video data,
a transfer frame selector adapted to transmit the selected frames of encoded digital video data from the video processing unit to the transfer buffer when remaining capacity of the transfer buffer is larger than a set value, the transfer frame selector dropping a frame outputted from the video processing unit when it is an inter-frame and a remaining capacity of the transfer buffer is smaller than the predetermined value, the transfer frame selector dropping all frames of a GOP to which a current intra-frame belongs when a frame transmitted to the transfer buffer immediately preceding the current intra-frame is an intra-frame and the remaining capacity of the transfer buffer is smaller than the set value, the transfer frame selector transmitting the current intra-frame to the transfer buffer when the frame transmitted to the transfer buffer immediately preceding the current intra-frame is an inter-frame and the remaining capacity of the transfer buffer is smaller than the set value, and
a transmission unit adapted to extract the encoded video data temporarily stored in the transfer buffer and convert it into a transmission standard that meets a network state to transmit it; and
a storage unit, comprising
a storage frame selector adapted to receive from a user a number of frames to be recorded per unit time, to determine an integer value N by dividing a maximum number of frames outputted from the video processing unit per unit time by the number of frames to be recorded per unit time, storing one frame for every N frames for each GOP of the encoded video data transmitted from the video processing unit, and dropping other frames, and
a moving picture database for storing the frames selected by the storage frame selector.

2. A moving picture transmission method, comprising:
(a) processing a moving picture signal received from a moving picture input device to convert it into ordered data, and encoding the data using a modified MPEG coding method that fixes an object, selected as a reference frame of inter-frames in each Group of Pictures (GOP), to an intra-frame and to output frames comprising the encoded digital video data;
(b1) confirming a remaining capacity of a transfer buffer when at a start of a new frame of the encoded digital video data,
(b2) transmitting a current frame through the transfer buffer when the remaining capacity of the transfer buffer is larger than a set value,
(b3) dropping the current frame when the remaining capacity of the transfer buffer is smaller than the set value and the current frame is an inter-frame, and
(b4) dropping all frames of a group of pictures (GOP) to which the current frame belongs when the current frame is an intra-frame, a frame transmitted through the transfer buffer immediately preceding the current frame is an intra-frame, and the remaining capacity of the transfer buffer is smaller than the set value, and transmitting the current frame through the transfer buffer when the frame transmitted through the transfer buffer immediately preceding the current frame is an inter-frame, to transmit the encoded video data in real time at a data loss rate adapted to a variation in a network transmission rate; and
(c1) receiving from a user a number of frames to be recorded per unit time, and determining an integer value N by dividing a maximum number of output frames of the video data encoded at the step (a) per unit time, by the number of frames to be recorded per unit time, and
(c2) storing one frame for every N frames for each GOP of the encoded video data and dropping the other frames, to store the encoded video data in the number of storage frames per unit time previously set.

3. A moving picture transmission method, comprising:
(a) processing a moving picture signal received from a moving picture input device to convert it into ordered data, and encoding the data using a modified MPEG coding method that fixes an object, selected as a reference frame of inter-frames in each Group of Pictures (GOP), to an intra-frame and to output frames comprising the encoded digital video data;
(b1) confirming a remaining capacity of a transfer buffer when at a start of a new frame of the encoded digital video data,
(b2) transmitting a current frame through the transfer buffer when the remaining capacity of the transfer buffer is larger than a set value,
(b3) dropping the current frame when the remaining capacity of the transfer buffer is smaller than the set value and the current frame is an inter-frame, and
(b4) dropping all frames of a group of pictures (GOP) to which the current frame belongs when the current frame is an intra-frame, a frame transmitted through the transfer buffer immediately preceding the current frame is an intra-frame, and the remaining capacity of the transfer buffer is smaller than the set value, and transmitting the current frame through the transfer buffer when the frame transmitted through the transfer buffer immediately preceding the current frame is an inter-frame, to transmit the encoded video data in real time at a data loss rate adapted to a variation in a network transmission rate.
